(19) United States
(12) Patent Application Publication
(10) Pub. No.: US 2004/0051385 A1
(43) Pub. Date: Mar. 18, 2004

(54) Energy control circuit and method of SMPS (switching mode power supply) for PDP (plasma display panel)

(76) Inventor: Yoo-Jin Song, Cheonan-city (KR)

Correspondence Address: CHRISTIE, PARKER & HALE, LLP, 350 WEST COLORADO BOULEVARD, SUITE 500, PASADENA, CA, 91105, US

(21) Appl. No.: 10/459,378

(22) Filed: Jun. 10, 2003

(30) Foreign Application Priority Data
Jun. 12, 2002 (KR) 2002-32910

(51) Int. Cl. H02J 1/10; H02J 3/38; H02J 7/34

(52) U.S. Cl. 307/44

(57) ABSTRACT

Disclosed is an energy control circuit and method of a switching mode power supply (SMPS) for a plasma display panel (PDP), which includes an energy bank provided at an output of the SMPS for storing energy, and supplying current for driving the PDP; an active discharge controller for actively discharging the energy stored in the energy bank at time of power off for the PDP; a constant current unit and a constant voltage unit for recovering the actively discharged energy, and supplying a substantially constant current and a substantially constant voltage when the power off time occurs; a power converter for converting the energy actively discharged by the energy bank in response to the substantially constant voltage into power for the PDP following the power off time.

### CROSS REFERENCE TO RELATED APPLICATION

This application claims priority to and the benefit of Korean Patent Application No. 2002-0032910 filed on Jun. 12, 2002 in the Korean Intellectual Property Office, the content of which is incorporated herein by reference.

### BACKGROUND OF THE INVENTION

(a) Field of the Invention

The present invention relates to an energy control circuit and method of a switching mode power supply (SMPS) for a plasma display panel (PDP). More specifically, the present invention relates to an energy control circuit and method of an SMPS for a PDP for recovering energy through active discharge.

(b) Description of the Related Art

A PDP is a display system that displays images through high voltage and high current driving. Accordingly, to supply a peak current used for displaying images on the PDP, the SMPS for the PDP includes a capacitor energy bank with a high capacity capacitor mounted at the output end.

Since the high capacity capacitor has no discharge path because of the nature of plasma display systems that have no-load characteristics when the PDP is turned off, an operator may receive an electrical shock. Further, an output holdup time may be increased as compared to the logic power (generally 5V and 3.3V) for system control, so the PDP may malfunction and/or reliability may be reduced.

FIG. 1 shows a partial configuration of a conventional SMPS for a PDP.

As illustrated in FIG. 1, the SMPS for a PDP includes a capacitor energy bank 3 with high capacity capacitors for converting energy in response to a signal generated by a PWM (pulse width modulation) control circuit 1, and an active discharge control circuit 5 used to discharge the capacitor energy bank 3.

The active discharge control circuit 5 exhausts energy of the capacitor energy bank 3 by using discharge resistors Rd and an FET (field-effect transistor) Q2 when the PDP system is powered off. That is, the energy stored in the capacitor energy bank 3 is exhausted by discharging the energy stored in the capacitors through allowing a large current to flow through discharge resistors Rd, which typically have a low combined resistance.

Since the active discharge control circuit 5 uses the discharge resistors Rd having a low combined resistance so as to decrease an instantaneous discharge time during which the active discharge is executed, the energy exhausted by the discharge resistors Rd becomes large, and accordingly, resistors with high wattage and a high-current FET should be used for the active discharge of the capacitor energy bank 3.

The capacitor energy bank 3 is provided at an output of the SMPS using a high capacity capacitor (or capacitors) since the peak current provided by the output voltage Vs (i.e., an output voltage for sustaining the PDP) at Vout is large.

The capacitor energy bank 3 stores a large amount of energy and provides the peak current that instantaneously flows at Vout so as to not be burdensome to the SMPS, thereby enabling an easy SMPS design and reducing stresses on the components therein.

FIG. 2 shows a power sequence for an active discharge in the SMPS of FIG. 1.

Since switches of a driver are stopped in the PDP system when they are powered off, the capacitor energy bank 3 should be discharged over time. However, it is problematic for the operator to handle the printed circuit board (PCB) that includes the SMPS because of energy remaining in the capacitor energy bank 3.

Also, since the input voltages of a logic board and a video board for controlling the whole PDP system are respectively 3.3V and 5V, which are very low, the input voltages are severely lowered as shown in FIG. 2 when the power is turned off, and hence, the high voltage is maintained and the control signal is removed, thereby lowering the system reliability.

To compensate for the above-noted problem, the active discharge control circuit 5 is mounted on the SMPS to discharge residual energy of the energy bank to ground through the discharge resistors Rd when the power is turned off. Also, the active discharge control circuit 5 may include a complex power sequence circuit to make the voltages of the logic board and the video board fall.

The current of Vout/Rd flows through the discharge resistors Rd during the active discharge, and the low resistance of Rd is used so as to minimize or reduce the discharge time.

Since the discharge resistors Rd and the high-current FET Q2 occupy a large space on the SMPS PCB, component crowding of the SMPS may be worsened, component stress may increase because of the large current flowing through the discharge resistors Rd at the time of power-off, and reliability may decrease because of malfunctions.

Further, in the case of high voltages such as the output voltage for sustaining the PDP and an output voltage for addressing the PDP, it is difficult to control the system sequence even though the discharge may be performed very fast.

### SUMMARY OF THE INVENTION

In an exemplary embodiment in accordance with aspects of the present invention, there is provided an energy control circuit and method of an SMPS for a PDP for recovering the energy that is actively discharged from a capacitor energy bank at the time of power off.

In one exemplary embodiment of the present invention, an energy control circuit of an SMPS for a PDP includes: an energy bank provided at an output of the SMPS for storing energy, and supplying current for driving the PDP; an active discharge controller for actively discharging the energy stored in the energy bank at time of power off for the PDP; a constant current unit for recovering the actively discharged energy, and supplying the recovered energy as a substantially constant current when the power off time occurs; a constant unit for supplying a substantially constant voltage when the substantially constant current is supplied by the constant current unit; and a power converter for converting the energy actively discharged by the energy bank in response to the substantially constant voltage supplied by the constant voltage unit into power for the PDP following the power off time.

In another exemplary embodiment of the present invention, the constant current unit includes a FET through which the substantially constant current flows.

In yet another exemplary embodiment of the present invention, the constant voltage unit includes a Zener diode for providing the substantially constant voltage, and a capacitor for supplying the substantially constant voltage to the power converter.

In still another exemplary embodiment of the present invention, the power converter includes a buck converter for outputting a voltage lower than the substantially constant voltage supplied by the constant voltage unit following the power off time.

In a further exemplary embodiment of the present invention, an energy control method of an SMPS for a PDP includes: (a) actively discharging energy stored in an energy bank for supplying current to the PDP following time of power off for the PDP; (b) recovering the energy exhausted through the active discharge; (c) supplying the recovered energy as a substantially constant current and a substantially constant voltage; and (d) converting the substantially constant current and the substantially constant voltage into power for the PDP following the power off time.

In a still further exemplary embodiment of the present invention, (d) converting the substantially constant current and the substantially constant voltage includes down converting the substantially constant voltage to an output voltage of approximately 5 volts.

In a yet further exemplary embodiment of the present invention, an energy control circuit of an SMPS for a PDP includes an energy bank provided at an output of the SMPS for storing energy, said energy being used as power for the PDP following time of power off for the PDP; and a power converter for converting the energy into the power for the PDP following the power off time.

### BRIEF DESCRIPTION OF THE DRAWINGS

The accompanying drawings, which together with the specification, illustrate exemplary embodiments of the present invention, and, together with the description, serve to explain the principles of the present invention:

FIG. 1 shows a partial configuration of a conventional SMPS for a PDP;

FIG. 2 shows a power sequence for an active discharge in the SMPS of FIG. 1;

FIG. 3 shows an energy control circuit of an SMPS for a PDP in an exemplary embodiment of the present invention;

FIG. 4 shows a flowchart of an energy control method of an SMPS for a PDP in an exemplary embodiment of the present invention; and

FIG. 5 shows a power sequence caused by active discharge and energy recovery using the energy control circuit of FIG. 3.

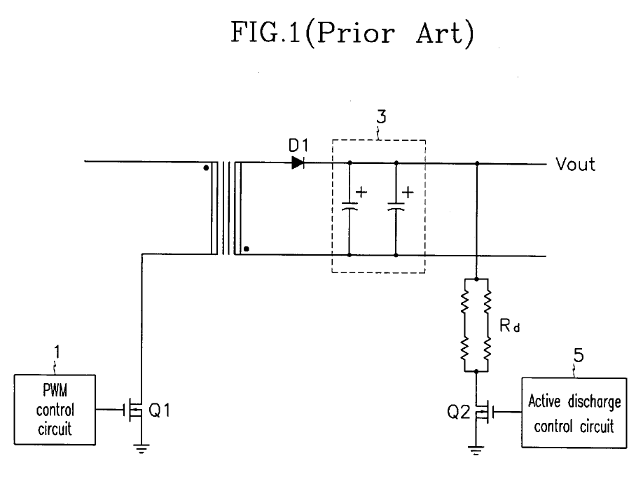

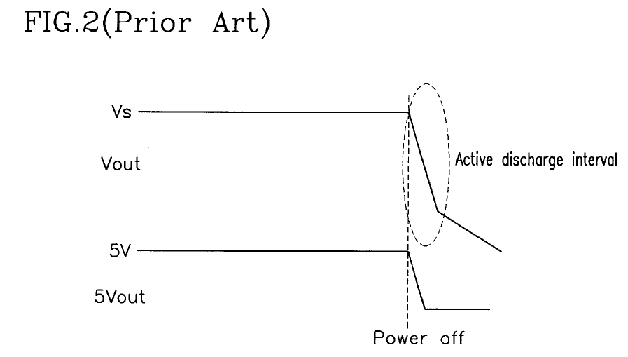

### DETAILED DESCRIPTION

In the following detailed description, exemplary embodiments of the present invention are shown and described, by way of illustration. As those skilled in the art would recognize, the described exemplary embodiments may be modified in various different ways, all without departing from the spirit or scope of the present invention. Accordingly, the drawings and description are to be regarded as illustrative in nature, and not restrictive.

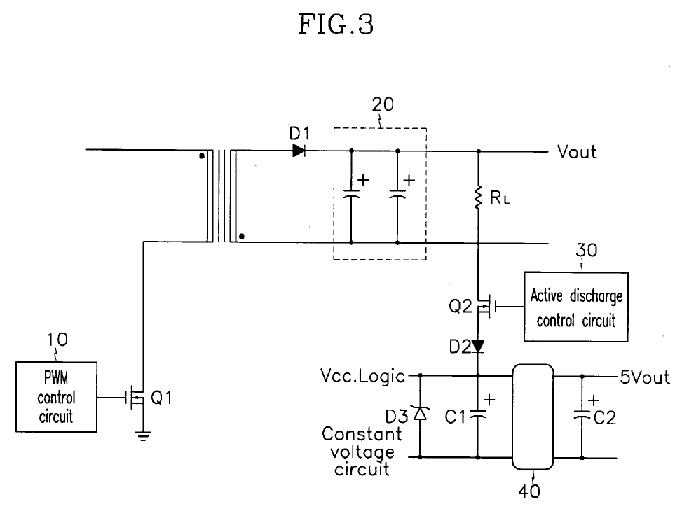

FIG. 3 shows an energy control circuit of an SMPS for a PDP in an exemplary embodiment of the present invention.

As illustrated in FIG. 3, the energy control circuit is provided at an output end of the SMPS for supplying a high voltage and a high current for driving a PDP using a PWM input signal of a PWM control circuit 10, and executes active discharge and energy recovery operations.

The energy control circuit includes an energy bank 20 for storing a large amount of energy in high capacity capacitors, and supplying a peak current at Vout for driving a PDP; an active discharge control circuit 30 for actively discharging the energy stored in the energy bank 20 at the time of power off (e.g., in response to a detection of power off); a constant current FET Q2 for turning on when the power off is detected (i.e., when the power off occurs), recovering the actively discharged energy, and supplying the energy as a substantially constant current that flows through itself; a Zener diode D3 for providing a substantially constant voltage when the substantially constant current is supplied by the constant current FET Q2 and/or in response to such substantially constant current; a capacitor C1 for supplying the substantially constant voltage in response to the substantially constant current together with the Zener diode D3; and a buck converter 40 for recovering the energy actively discharged by the energy bank 20 in response to the substantially constant voltage supplied by the Zener diode D3 and the capacitor C1, and converting the energy into power for the PDP following the power off time.

In this instance, the buck converter 40 outputs a voltage at 5Vout that is lower than the substantially constant voltage supplied by Zener diode D3 and the capacitor C1. By way of example, the buck converter 40 outputs an output voltage of approximately 5 volts in the power off state (i.e., following the power off time for the PDP) in the described exemplary embodiment.

Also, a diode D2 is installed between the constant current FET Q2 and the Zener diode D3.

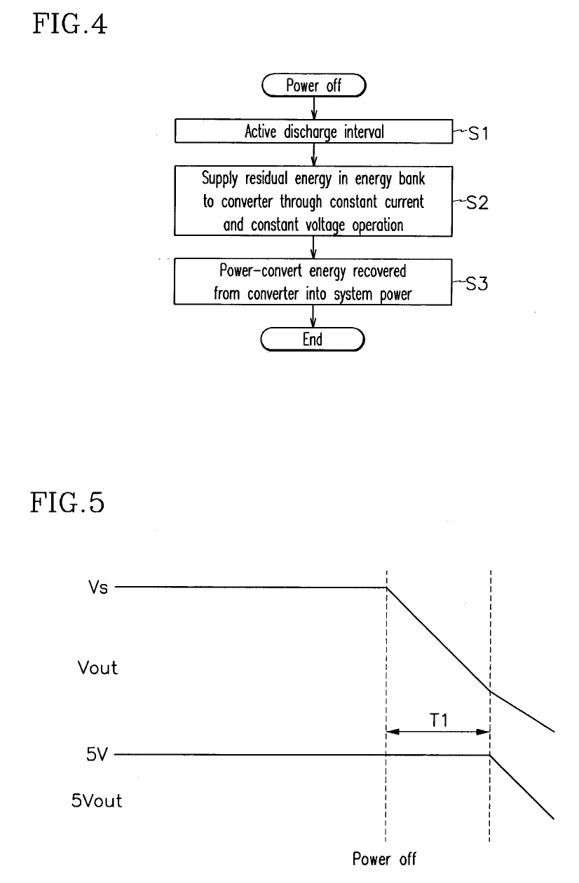

An operation of the energy control circuit of the SMPS for the PDP will now be described in reference to FIGS. 4 and 5.

FIG. 4 shows a flowchart of an energy control method of the SMPS of the PDP in an exemplary embodiment of the present invention.

As shown, the active discharge control circuit 30 is operated when the power is off (e.g., when the power off is detected), and it actively discharges the energy stored in the energy bank 20 in step S1. To discharge the energy, the active discharge control circuit 30 turns on the constant current FET Q2 to exhaust the residual energy in the energy bank 20 as a substantially constant current, and the Zener diode D3 and the capacitor C1 provide a substantially constant voltage to the buck converter 40 in step S2.

The buck converter 40 uses the substantially constant voltage supplied by the Zener diode D3 and the capacitor C1 to recover the residual energy in the energy bank and outputs at 5Vout an output voltage of approximately 5 volts under the power off state (i.e., following the power off time) in step S3.

Since the energy recovered by the buck converter 40 is used as logic power for the PDP system, a power sequence for the PDP system can be realized without an additional power sequence circuit.

FIG. 5 shows a power sequence caused by active discharge and energy recovery using the energy control circuit of FIG. 3.

As shown, the interval T1 represents an interval for supplying the energy of the sustaining voltage Vs for the PDP at the output voltage Vout to the buck converter 40. Since the falling start time of the output voltage 5Vout of the buck converter 40 lags behind Vout because of the interval T1, an additional power sequence for the PDP system may not be required.

The energy control circuit and method of the SMPS for the PDP in exemplary embodiments the present invention recovers the energy exhausted through the active discharge of the capacitor energy bank and uses it as a system power for PDP logic following the time of power off, thereby optimizing or improving the active discharging and the power sequence.

Also, the energy control circuit and method of the SMPS for the PDP in exemplary embodiments of the present invention recovers the energy exhausted through the active discharge to reduce stresses of the components and dangers of malfunctions, thereby improving the reliability of the system and enabling SMPS components to occupy a smaller space, e.g., through making them smaller and lighter.

Further, since the energy control circuit and method of the SMPS for the PDP in exemplary embodiments of the present invention recovers the energy exhausted through the active discharge and uses the same as a logic source of the system, the power sequence of the PDP system can be realized without an additional power sequence circuit.

While this invention has been described in connection with specific exemplary embodiments, it is to be understood that the invention is not limited to the disclosed embodiments, but, on the contrary, is intended to cover various modifications and equivalent arrangements included within the spirit and scope of the appended claims.

What is claimed is:

1. An energy control circuit of a switching mode power supply (SMPS) for a plasma display panel (PDP) comprising:
an energy bank provided at an output of the SMPS for storing energy, and supplying current for driving the PDP;
an active discharge controller for actively discharging the energy stored in the energy bank at time of power off for the PDP;
a constant current unit for recovering the actively discharged energy, and supplying the recovered energy as a substantially constant current when the power off time occurs;
a constant voltage unit for supplying a substantially constant voltage when the substantially constant current is supplied by the constant current unit; and
a power converter for converting the energy actively discharged by the energy bank in response to the substantially constant voltage supplied by the constant voltage unit into power for the PDP following the power off time.

2. The circuit of claim 1, wherein the constant current unit comprises a FET (field-effect transistor) through which the substantially constant current flows.

3. The circuit of claim 2, wherein the constant voltage unit supplies the substantially constant voltage in response to the substantially constant current supplied by the constant current unit.

4. The circuit of claim 1, wherein the constant voltage unit comprises a Zener diode for providing the substantially constant voltage, and a capacitor for supplying the substantially constant voltage to the power converter.

5. The circuit of claim 1, wherein the power converter comprises a buck converter for outputting a voltage lower than the substantially constant voltage supplied by the constant voltage unit following the power off time.

6. The circuit of claim 1, wherein a voltage of the energy stored in the energy bank starts to decrease at the power off time.

7. The circuit of claim 6, wherein the voltage outputted by the power converter starts to decrease following a time interval after the power off time.

8. The circuit of claim 2, wherein the constant current unit further comprises a diode in series with the FET and in a flow path of said substantially constant current.

9. An energy control method of a switching mode power supply (SMPS) for a plasma display panel (PDP) comprising:
(a) actively discharging energy stored in an energy bank for supplying current to the PDP following time of power off for the PDP;
(b) recovering the energy exhausted through the active discharge;
(c) supplying the recovered energy as a substantially constant current and a substantially constant voltage; and
(d) converting the substantially constant current and the substantially constant voltage into power for the PDP following the power off time.

10. The method of claim 9, wherein converting the substantially constant current and the substantially constant voltage comprises down converting the substantially constant voltage to an output voltage of approximately 5 volts.

11. The method of claim 9, wherein recovering the energy comprises allowing the energy to flow as the substantially constant current.

12. The method of claim 11, wherein supplying the recovered energy comprises providing the substantially constant voltage in response to the substantially constant current.

13. The method of claim 12, wherein converting the substantially constant current and the substantially constant voltage comprises down converting the substantially constant voltage using a buck converter.

14. The method of claim 13, wherein actively discharging the energy comprises turning on a field effect transistor (FET) coupled between the energy bank and the buck converter.

15. An energy control circuit of a switching mode power supply (SMPS) for a plasma display panel (PDP) comprising:
an energy bank provided at an output of the SMPS for storing energy, said energy being used as power for the PDP following time of power off for the PDP; and
a power converter for converting the energy into the power for the PDP following the power off time.

16. The circuit of claim 15, further comprising an active discharge controller responsive to the power off for actively discharging the energy stored in the energy bank following the power off time.

17. The circuit of claim 16, further comprising a constant current unit responsive to the active discharge controller for recovering the actively discharged energy and supplying the recovered actively discharged energy as a substantially constant current.

18. The circuit of claim 17, further comprising a constant voltage unit responsive to the substantially constant current for generating a substantially constant voltage.

19. The circuit of claim 18, further comprising a power converter for converting the substantially constant voltage and the substantially constant current to the power for the PDP following the power off time.

20. The circuit of claim 19, wherein there is a time interval between when a voltage of the energy in the energy bank starts to decrease in magnitude and a voltage for the power for the PDP following the power off time starts to decrease in magnitude.
